(19) United States
(12) Patent Application Publication
(10) Pub. No.: US 2020/0344426 A1
(43) Pub. Date: Oct. 29, 2020

(54) THERMAL RANGING DEVICES AND METHODS

(71) Applicant: Owl Autonomous Imaging, Inc., Fairport, NY (US)

(72) Inventors: Eugene M. Petilli, Victor, NY (US); Francis J. Cusack, JR., Raleigh, NC (US)

(21) Appl. No.: 16/849,763

(22) Filed: Apr. 15, 2020

Related U.S. Application Data
(60) Provisional application No. 62/834,066, filed on Apr. 15, 2019.

(51) Int. Cl. H04N 5/33; G01J 5/30; G06T 1/20

(52) U.S. Cl. CPC H04N 5/33; G01J 2005/0077; G06T 1/20; G01J 5/30

(57) ABSTRACT

An embodiment of a device is disclosed. The device includes a lens, operative in the infrared, configured to receive an image of a field of view of the lens, a microlens array, operative in the infrared, optically coupled to the lens and configured to create an array of light field images based on the image, a photodetector array comprising a plurality of non-silicon photodetectors, photosensitive in at least part of the thermal spectrum from 3 microns to 14 microns, the photodetector array being optically coupled to the microlens array and configured to generate output signals from the non-silicon photodetectors based on the array of light field images, and a read-out integrated circuit (ROIC) communicatively coupled to the photodetector array and configured to receive the signals from the photodetector array, convert them to digital signals and to output digital data.

### FIELD

This disclosure relates generally to thermal image and range acquisition devices and methods thereof.

### BACKGROUND

Autonomous vehicles represent one of the most exciting and promising technologies to emerge in the last decade, offering the potential to disrupt the economics of transportation. There is plenty of promise, but there can be no doubt that the emergence of fully autonomous vehicles will have a lasting impact on people's lives and the global economy.

Sensors are among the many technologies needed to construct fully autonomous driving systems. Sensors are the autonomous vehicle's eyes, allowing the vehicle to build an accurate model of the surroundings from which Simultaneous Location And Mapping (SLAM) and Path planning decisions can be made safely and comfortably. Sensors will play an enabling role in achieving the ultimate goal of autonomous driving, i.e., fully driverless vehicles.

While sensor technology has enabled impressive advances in autonomous vehicle technology, car manufacturers have struggled to achieve a fully autonomous vehicle. One of the most important barriers to full autonomy is the lack of cost-effective sensors capable of reliably identifying objects, particularly animate objects, including their 3D location under a wide range of environmental conditions.

There are four types of SLAM sensor systems currently employed in self-driving cars; passive 2D visible and thermal cameras, and active 3D LiDAR, and RADAR. Each sensor type has unique strengths and limitations. Visible cameras can deliver very high-resolution color video but struggle in adverse weather conditions and darkness. These drawbacks can be overcome with thermal cameras that sustain high resolution performance in most weather and throughout the day and night, and excel at detecting animate objects, but thermal cameras don't deliver color and can be more expensive. Both visible and thermal cameras can be used to support object classification, but visible and thermal cameras only deliver 2D video and therefore need to operate alongside a sensor that delivers range.

LiDAR and RADAR measure range and velocity. RADAR is widely used in military and marine applications and delivers excellent all-weather performance albeit with relatively low-resolution data. RADAR is essentially an object detector with limited potential for detailed object classification. LiDAR delivers range data with much more resolution than RADAR but far less 2D resolution than either visible or thermal cameras. LiDAR can offer some classification potential at shorter ranges but at longer ranges LiDAR becomes primarily an object detector.

One method of producing 3D image and video data not currently applied to autonomous vehicles is light-field imaging implemented as a plenoptic camera. Plenoptic cameras take many perspectives of a scene with each snapshot so that the parallax data between perspectives can be analyzed to yield range or depth data. Very few plenoptic cameras exist, and the only known current commercial supplier, Raytrix, manufactures cameras that operate on reflected light in the visible and near infrared bands as is compatible with silicon photodetectors. Most examples of plenoptic cameras produce still images at very short ranges (e.g., <1 meter) and have been effective in applications not well suited to multi-camera viewing such as live combustion flame size and shape characterization.

Visible light systems and methods related to light-field cameras are further described in, for example, Levoy et al., “Synthetic aperture confocal imaging,” published in 2004, (ACM SIGGRAPH 2004 papers, Los Angeles, Calif.: ACM, pages 825-834) and Ng et al., “Light field photography with a hand-held Plenoptic camera,” Stanford University (2005). Most known plenoptic prior art explicitly specifies silicon (e.g., CMOS) focal planes for visible (RGB) color and NIR applications but does not contemplate the applicability of light-field imaging for thermal ranging.

The current state of the art in autonomous vehicles is still searching for the optimal balance of sensors to detect and classify surrounding objects at ranges near and far and at relative vehicle closing speeds from stationary to in excess of 150 mph. Indeed, it's not uncommon to see development vehicles featuring several sensors of all four sensor types in an effort to realize reliable and safe autonomous operation.

### SUMMARY

An embodiment of a device is disclosed. The device includes a lens, operative in the infrared, configured to receive an image of a field of view of the lens, a microlens array, operative in the infrared, optically coupled to the lens and configured to create an array of light field images based on the image, a photodetector array comprising a plurality of non-silicon photodetectors, photosensitive in at least part of the thermal spectrum from 3 microns to 14 microns, the photodetector array being optically coupled to the microlens array and configured to generate output signals from the non-silicon photodetectors based on the array of light field images, and a read-out integrated circuit (ROIC) communicatively coupled to the photodetector array and configured to receive the signals from the photodetector array, convert them to digital signals and to output digital data.

In an embodiment of the device, a vacuum package encloses the detector and the ROIC.

In an embodiment of the device, an optical window predominantly transmissive to IR radiation optically couples the lens to the microlens array.

In an embodiment of the device, the photodetector array comprises a plurality of photodetectors sensitive to the MWIR band.

In an embodiment of the device, the photodetector array comprises a plurality of photodetectors sensitive to the LWIR band.

In an embodiment of the device, the photodetector array is a Strained Lattice (including T2SL and nBn) 2D array hybridized to the ROIC and fabricated with at least one of GaSb and InSb and GaAs and InAs and HgCdTe.

In an embodiment of the device, the photodetector array is deposited onto the ROIC and fabricated from at least one of VOx microbolometer and a poly-silicon microbolometer and a polycrystalline microbolometer and Colloidal Quantum Dots.

In an embodiment of the device, the photodetector array comprises a plurality of quantum dots photodetectors.

In an embodiment of the device, the non-silicon photodetectors comprise Colloidal Quantum Dots that are used in a photovoltaic mode of operation.

In an embodiment of the device, the photodetector array comprises a plurality of photovoltaic photodetectors.

In an embodiment of the device, the photodetector array comprises a plurality of photoconductive photodetectors.

In an embodiment of the device, each lenslet within the microlens array has at least one of an infrared pass coating and an infrared block coating.

In an embodiment of the device, the photodetector array is thermally coupled to an active cooler that cools the photodetector array to a temperature in the range of 77 Kelvin to 220 Kelvin.

In an embodiment of the device, the active cooler is a Stirling cooler.

In an embodiment of the device, the active cooler is a Thermal Electric Cooler (TEC) in thermal contact with the ROIC and at least partially enclosed in the package vacuum.

In an embodiment of the device, a cold plate of the TEC is also a printed circuit board (PCB) providing electrical interface to the ROIC.

In an embodiment of the device, the ROIC includes a plurality of Through Silicon Via (TSV) interconnects used to transmit controls and data to/from the ROIC.

In an embodiment, the device further includes a digital output based on at least one of MIPI CSI-2 and GigE and Camera-Link.

In an embodiment of the device, the lens and microlens array are configured as a contiguous depth-of-field plenoptic V2.0 system.

In an embodiment of the device, a computational photograph is performed by software on a Graphics Processing Unit (GPU).

In an embodiment of the device, the microlens array comprises spherical lenslets.

In an embodiment of the device, the microlens array comprises aspherical lenslets.

In an embodiment of the device, lenslets that comprise the microlens array have asymmetrical X & Y dimensions.

In an embodiment of the device, the microlens array comprises lenslets arranged in a hexagonal pattern.

In an embodiment of the device, the microlens array comprises lenslets arranged in an orthogonal pattern.

In an embodiment of the device, the microlens array comprises lenslets of at least one of dissimilar sizes and dissimilar shapes.

In an embodiment of the device, a plenoptic digital image output has greater than or equal to 21:9 aspect ratio.

In an embodiment of the device, a processor computes at least two depths of field based on thermal plenoptic data.

In an embodiment, a ranging system includes the device and a processor configured to generate data to reconstitute at least one of a two-dimensional and three-dimensional image of the field of view based on the digital data received from the ROIC.

In an embodiment of the ranging system, the processor is configured to compute at least two depths of field based on the digital data received from the ROIC.

In an embodiment of the device, the ROIC includes a plurality of analog sense amplifiers responsive to said infrared detectors, a plurality of Analog to Digital Converters (ADC) responsive to a plurality of said sense amplifiers, a light-field image digital output, and a digital acquisition controller.

A method of determining a thermal image is also disclosed. The method involves receiving, through a lens operative in the infrared, an image of a field of view of the lens, creating an array of light field images based on the image, from a microlens array, operative in the infrared, and optically coupled to the lens, sensing, by a plurality of non-silicon infrared detectors, the array of light field images, digitizing, by a silicon based Read Out Integrated Circuit (ROIC), an output from the non-silicon detectors, and generating output signals, based on the array of light field images.

In an embodiment, the method further includes generating an image including at least one of range and shape and depth information of an object in the field of view based on the light field data.

In an embodiment of the method, the ROIC includes a plurality of analog sense amplifiers responsive to said infrared detectors, a plurality of Analog to Digital Converters (ADC) responsive to a plurality of said sense amplifiers, a light-field image digital output, and a digital acquisition controller.

### BRIEF DESCRIPTION OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. In the drawings:

FIG. 1 depicts a simplified schematic illustration of a conventional digital camera;

FIG. 2A depicts a simplified schematic illustration of an example of a plenoptic camera, wherein the plenoptic camera is of a type commonly referred to as a plenoptic 1.0 camera

FIG. 2B depicts an enlarged perspective view of the area 2B in FIG. 2A; showing an orthogonal arrangement of spherical microlenses

FIG. 2C depicts an enlarged perspective view of the area 2C in FIG. 2A; showing a hexagonal arrangement of spherical microlenses

FIG. 2D depicts an enlarged perspective view of the area 2D in FIG. 2A; showing a staggered arrangement of non-spherical microlenses.

FIG. 2E depicts an enlarged perspective view of the area 2E in FIG. 2A; showing another arrangement of non-spherical microlenses.

FIGS. 3A and 3B depict a simplified schematic illustration of plenoptic camera of FIG. 2A, wherein an additional angular subset of photons is shown;

FIG. 4 depicts a simplified schematic illustration of the plenoptic camera of FIG. 2A, wherein different collections of photodetectors are combined from different microlenses to form a new focal plane;

FIG. 5 depicts a simplified illustration of the plenoptic camera of FIG. 2A, wherein a new focal plane is formed to mitigate the effects of obscurants;

FIG. 6 depicts a simplified schematic illustration of another plenoptic camera, wherein this plenoptic camera is of a type commonly referred to as a plenoptic 2.0 camera;

FIG. 7 depicts a simplified schematic illustration of a thermal ranging plenoptic camera in accordance with an embodiment of the present invention;

FIG. 8 depicts a simplified schematic illustration of another thermal ranging plenoptic camera in accordance with an embodiment of the present invention.

FIG. 9 depicts a simplified schematic illustration of a thermal ranging plenoptic camera, graphical processing unit and communications link.

### DETAILED DESCRIPTION

When discussing imaging, it is important to understand the wavelength of light being captured. For the purposes of this discussion, we will consider the following bands of wavelengths: Visible (400 nm-750 nm), NIR (750 nm-1 um), SWIR (1 um-2 um), MWIR (3 um-5 um), and LWIR (8 um-14 um). Objects emit very little light below 3 um and therefore reflected light is the primary signal detected up to 3 um, which therefore requires an illumination source. Infrared light above 3 um is radiated from objects as thermal energy and does not require a separate illumination source for detection. Shorter wavelengths also tend to have higher bandwidths and higher spatial resolution. For these two reasons, most LiDAR systems operate in either NIR or SWIR bands to deliver the highest fidelity data. 2D MWIR cameras can produce higher resolution 2D imagery than LWIR and the detector pixel pitch can be made smaller than LWIR due to the shorter wavelength. Modern millimeter wave radar operates at longer wavelengths than LWIR but suffers from low angular detection resolution, compared to for example far infrared (FIR) microbolometer wavelengths.

Therefore, an ideal sensor for autonomous vehicle applications will be one that offers the best attributes of the existing sensors. The ideal sensor should offer excellent 2D spatial resolution which equates to the fidelity of the image data and the sensor's ability to resolve details necessary for object detection and classification. The sensor should offer 3D data so that a sense of scale and distance can be applied to the 2D data. Without this range data, it is very difficult to classify detected objects. But the 3D data should not come at the cost of eye safety or radio wave exposure. The ideal sensor should also operate in nearly all weather and at all times. And finally, the sensor should be small and simple, with few or no moving parts for the best possible reliability.

What is disclosed herein is a thermal ranging plenoptic camera capable of producing 3D video in the MWIR and LWIR bands. This innovative camera can produce high resolution 2D data and range data of sufficient resolution to detect and classify objects at ranges relevant to autonomous vehicles, for example 3-250 meters. The camera can work in tandem with computational imaging, on either an integrated or attached processor, to provide flexible interpretation of the Plenoptic data. The thermal ranging plenoptic camera, working in conjunction with a processor, is able to detect objects, classify detected objects, and even image in cross sections through regions of interest to mitigate the effects of suspended aerosol, obscurants, and fixed obstructions by computationally modifying the effective focal length of the lens.

A key to overcoming deficiencies in the current art lies in the means to passively generate 3D data, consisting of 2D data of sufficiently high spatial resolution and with associated range, depth, or shape data, and operating at wavelengths proven effective in most weather conditions while remaining effective at all times of day or night. It is possible to produce 3D infrared data from a 2D infrared imager featuring a single focal plane array through the use of a thermal ranging plenoptic camera and light-field imaging.

Light-field imaging was proposed by Gabriel Lippmann in 1908. The plenoptic camera captures not only the intensity of the incident light, but also the direction the light rays are traveling, to create a single image comprised of many perspectives resulting in a 4D image comprised of two spatial dimensions (x, y) and two viewing dimensions (Vₛ, Vₛ). Originally conceived to operate at visible wavelengths, the plenoptic concept is valid for any electromagnetic band from Near infrared (NIR), to Longwave infrared (LWIR) and beyond.

A plenoptic camera can recover range, depth, and shape information from a single exposure and through a single compact aperture (unlike stereoscopic systems). In 1992, Adelson and Wang proposed a plenoptic camera featuring a microlens array (MLA), Adelson, Edward H, Wang, John “Single Lens Stereo with a Plenoptic Camera”. IEEE Transactions on Pattern Analysis and Machine Intelligence, Vol. 14, No. 2, February 1992. By placing a two-dimensional array of lenslets responsive to thermal energy (i.e., light or radiation) in the thermal camera optics, a corresponding number of thermal sub-aperture images are created, where each image presents a slightly different perspective of the scene (in concept like thousands of stereo image pairs captured instantly from one camera).

Three-dimensional thermal imagery can be constructed by using “computational imaging” of the geometric projection of rays, comprising the thermal light rays' intensity and angle information, a technique of indirectly forming images through computation instead of simple optics. Analyzing two or more thermal rays that view the same object from different perspectives reveals a parallax, or registered pixel disparity, that when quantified can in turn reveal information about the range to an object, or depth and shape information about an object.

A key to realizing depth data from sensors relying on parallax data, including thermal ranging plenoptic imagers and thermal stereoscopic imagers alike, lies in the means to accurately register two images. Image registration is the process of transforming two or more different data sets, for example, two thermal images, into a common coordinate system. In the field of imaging, the two images may for example come from the same sensor at two different times, or from two different sensors viewing the same scene at the same time as in stereoscopic imaging, or from a single-aperture sensor employing a micro-lens array as found in plenoptic imagers.

With a thermal ranging plenoptic imager, an array of lenslets will produce a thermal sub-aperture image for each microlens, and therefore present many opportunities for sub-aperture image pairing and requisite image registration operations. Following successful registration of a thermal image pair, automated computational imaging techniques can be applied to derive depth measurements from many points within the scene of each image pair, where the points correspond to a common point in the object plane. Importantly, many of the depth calculations within an image pair may be based on both X and Y dimensional data, and also based on data that may be to some degree redundant with other lenslet pairs, so that an additional degree of confidence and robustness can be realized holistically across the entire reconstituted image. This provides a distinguishing advantage over stereoscopic sensors that have but one image pair per capture moment from which to derive range data.

The task of thermal image registration is well suited to automated computations, with modern processors using mathematical techniques collectively referred to as “computational imaging” of the geometric projection of thermal rays, which indirectly forms images through computation instead of simple optics. Computational imaging is now in widespread use in applications such as tomographic imaging, MRI, and synthetic aperture radar (SAR). A thermal ranging plenoptic camera can recover range, depth, and shape information from a single exposure and through a single compact aperture (unlike stereoscopic systems).

Plenoptic cameras trade off some 2D resolution to create 3D imagery. Advanced computational imaging techniques commonly referred to as “Super Resolution” have proven successful at reclaiming some of the 2D resolution traditionally lost to the light-field imager.

A thermal ranging plenoptic camera, sensitive to MWIR and/or LWIR radiation, with a digital focal plane array (DFPA) is disclosed herein. In an embodiment, the thermal plenoptic ranging camera for 4D thermal light-field detection includes plenoptic optics including a main lens and a printed film or micro-lens array, a single focal plane including multiple non-silicon detectors responsive to infrared radiation and a silicon Read Out Integrated Circuit (ROIC). The thermal ranging plenoptic camera may be coupled to a digital acquisition and computational photography device to process the data output from the thermal ranging plenoptic camera. In an embodiment, the ROIC generates thermal image frame data over a region of interest and consecutive frames can constitute a video stream. Computational photography can be used to extract 3D (2D intensity plus depth) images as well as selective depth-of-field and image focus from the acquired 4D thermal light-field data.

To detect radiated energy, the sensor array should be responsive to a band of wavelengths between 3 um and 14 um. Silicon detectors are typically limited to visible and NIR wavelengths up to 1.1 um and are not suitable for thermal ranging applications, regardless of optical filters utilized. Some MWIR and LWIR detectors can operate at room temperatures, however, others need to be cooled, often to cryogenic temperatures as low as 77K (liquid nitrogen). Even IR detectors that can operate at room temperature perform better when cooled. There is currently research and industry interest for High Operating Temperature (HOT) MWIR detectors that typically operate at 150K but occasionally operate as high as 170K. These cryogenic temperatures often require the use of a cooler such as a Stirling cooler. More modest temperatures of 200K (−73° C.) can be achieved with Thermo-Electric Coolers (TEC).

Thermal detectors are typically either Photovoltaic or Photoconductive devices. Microbolometers are typically photoconductive devices where the resistance of the detector changes with the temperature of the detector. As such, microbolometers tend to have long thermal time constants and may not be suitable for scenes with fast moving objects. Photovoltaic devices (such as photodiodes) directly convert photons to electrical carriers and tend to have faster time constants. Strained-Lattice devices (including Type-2 SL and nBn) and Colloidal Quantum Dots can exhibit a response similar to either photoconductive or photovoltaic devices, depending on fabrication and biasing techniques. Furthermore, the smallest practical pixel pitch in the detector array is proportional to the imaging wavelength and therefore MWIR pixels can be made smaller than LWIR pixels. Since capacitance is proportional to pixel area, MWIR detectors typically have higher bandwidth than LWIR. Since autonomous vehicles are moving fast with respect to oncoming vehicles, it is desirable to select a photovoltaic detector operating in the MWIR band to produce images and video of optimal clarity.

IR cameras are difficult to build due to the reality that silicon-based detectors typically are only responsive to wavelengths below 1.1 um. Silicon detector arrays make inexpensive visible light cameras possible, for example, as found in cellphones, but are unusable for thermal imaging in the MWIR or LWIR bands. IR detector arrays engineered from Super Lattice (SL) materials, including nBn, need to be hybridized to a silicon Read Out Integrated Circuit (ROIC) which amplifies and digitizes the non-silicon detector signals. Alternatively, MEMS techniques can be used to deposit material that responds to incident heat or light, such as photoconductive micro-bolometer or photovoltaic Colloidal Quantum Dot (CQD) detectors respectively, directly onto the ROIC.

An additional complication with thermal imaging is that IR wavelengths do not transmit through glass, making lens design more challenging. Typical infrared lens materials used for optical elements include Germanium, Sapphire, Silicon and moldable Chalcogenide composites.

A thermal ranging plenoptic camera that captures 4D radiated band (MWIR, LWIR) light-fields and leverages computational imaging to extract 3D range information without the need for an illuminator can be valuable to the autonomous car market. Such a “Thermal Ranging” camera can be made using infrared plenoptic optics and a non-silicon IR detector coupled to a silicon ROIC. Unlike its less expensive visible light silicon detector counterparts, the thermal imaging capability of such a thermal ranging plenoptic camera can see through most bad weather and greatly simplifies classification of animate vs. inanimate objects based on differences in heat signatures.

After the thermal plenoptic image data is collected by the thermal ranging plenoptic camera, computational imaging can also virtually change the effective focal length of the system and refocus the single exposure to create multiple depth-of-fields (DoF). Due to the fact that the thermal ranging plenoptic camera captures light from multiple angles simultaneously, it is possible through computational photography of MWIR (or LWIR) light-fields to re-focus a single thermal exposure on multiple objects-of-interest at different ranges and thereby “see through” obscurants, even obscurants of moderate particle size, e.g., sand. The ability to refocus a thermal image or thermal video after it is captured in order to improve visibility through obscurants, such as sand and fog, is a unique capability of the thermal ranging camera that is not possible with traditional 2D imaging.

For example, autonomous vehicles can encounter decreased perception in Degraded Visual Environments (DVE) when the vehicle is in the presence of obscurants such as dust, snow, fog, and/or smoke. Since longer wavelengths penetrate small obscurants better, MWIR radiation transmits through fog and rain further than visible light or SWIR. This enables MWIR to better “see through” even moderate sized obscurants that cast a veil over traditional visible imaging sensors. Therefore, under DVE driving conditions, an autonomous vehicle equipped with a thermal ranging camera will continue to perceive objects and indicators, near or far, that provide the visual references necessary to safely control and navigate the vehicle (e.g., white and yellow lane markers, merge and turn arrows on tarmac, bridges, and underpasses, etc.).

Furthermore, the thermal ranging plenoptic camera can adaptively focus to where objects of interest are hiding behind obscurants using the plenoptic camera's unique digital focus capability. For example, vehicles up ahead that are partially or wholly obscured by DVE conditions may still be reliably perceived because the thermal ranging camera focuses on the vehicles of interest and not on the obscurants masking them. Therefore, a thermal ranging camera that includes plenoptic optics can be an essential component of an “always on” SLAM system to enable true autonomous vehicles in all weather conditions.

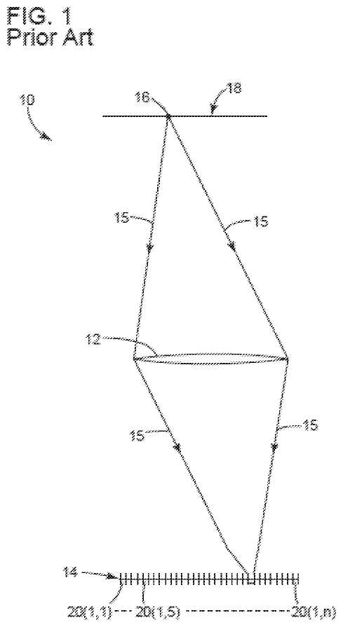

Referring to FIG. 1, a simplified schematic illustration of an exemplary prior art conventional digital camera 10 is depicted. The conventional digital camera includes a main lens 12 and a detector array 14. The main lens 12 maps light photons 15 emanating from a point 16 on an object plane 18 of an object of interest (not shown) onto the detector array 14.

In an embodiment, the detector array 14 includes a plurality of photon sensitive photodetectors 20(1, 1) to 20(m, n) arranged in m rows and n columns within the detector array 14. Each photodetector 20 generates an electric signal proportional to the number of photons 15 of light that hits the photodetector 20. As such, there is a one to one mapping of points 16 positioned on the object plane 18 to the photodetectors 20 positioned on the detection array 14. The number of photons 15 hitting a photodetector during one shutter actuation period (or integration period, or frame time) is indicative of the light intensity emanating from the point 16. From the intensity and position data, a two-dimensional picture of an object in the object plane 18 can be derived.

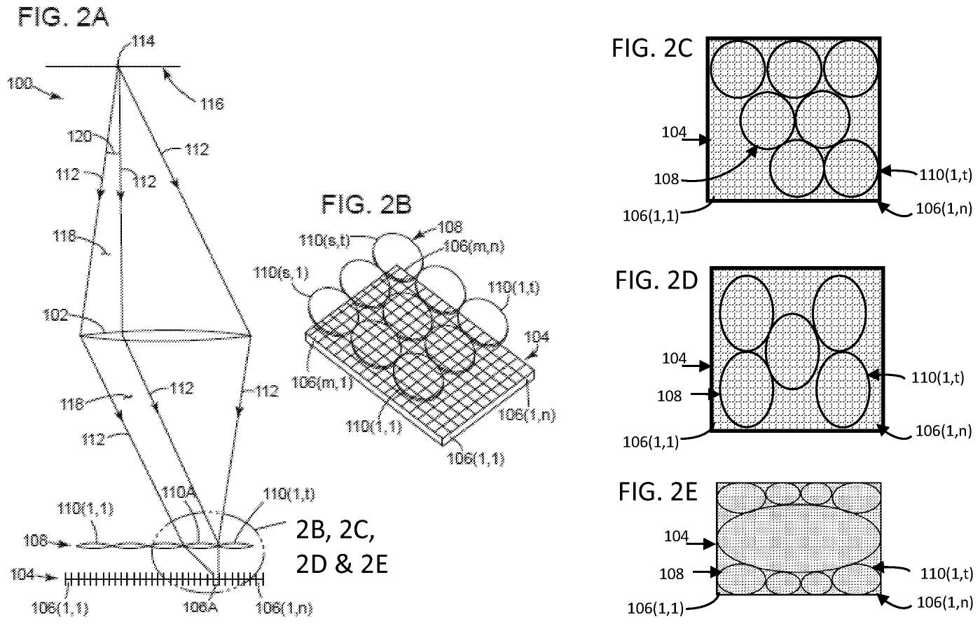

Referring to FIG. 2A, a simplified schematic illustration of an exemplary plenoptic camera 100. Similar to the conventional camera 10, the plenoptic camera 100 includes a main lens 102 and a detector array 104 of photodetectors 106 (e.g., 106 (1, 1) to 106 (m, n)). However, the plenoptic camera 100 also includes an array 108 of microlenses 110 (e.g., 110 (1, 1) to 110 (s, t)) positioned between the main lens 102 and the detector array 104. The array 108 of microlenses 110 is generally positioned closer to the detector array 104 than to the main lens 102.

In the plenoptic camera 100, the main lens 102 maps light photons 112 emanating from a point 114 on an object plane 116 of an object of interest (not shown) onto the microlens array 108. The microlens array 108 then maps the light photons 112 onto the detector array 104, which is located on an image plane (also referred to herein as a focal plane) of the plenoptic camera 100.

In this exemplary embodiment, the function of the microlens 110 in the microlens array 108 is to take angular subsets of the light photons 112 and focus those subsets onto specific photodetectors 106. For example, an angular subset 118 of the photons 112 emanating at a specific angle 120 (from the point 114) strikes a specific microlens 110A. Microlens 110A focuses that subset 118 onto several associated photodetectors 106 behind the microlens 110A. The associated photodetectors form a sub-array of photodetectors, such as, by way of a non-limiting example, photodetectors 106A through 106E. In other words, each microlens focuses light onto a sub-array of photodetectors where each sub-array of photodetectors includes a portion of the detector elements under the microlens. The sub-array of photodetectors may capture substantially all of the light rays (photons) 112 that are traveling within the angular subset 118 from the point 114 to the microlens 110A.

As illustrated in FIG. 2A, photodetector 106A is one such exemplary photodetector of the sub-array of photodetectors. However, there may be many photodetectors 106 that make up a sub-array of photodetectors. For example, there may be 10, 50, 100 or more photodetectors 106 that make up a sub-array of photodetectors associated with each microlens 110.

The microlenses 110 and photodetectors 106 each provide both spatial and perspective information relative to points (such as point 114) on the object plane 116. Spatial information, in this context, being indicative of positions on the object plane 116. Perspective information, in this context, being indicative of angles that light emanates from the object plane 116.

Referring to FIG. 2B, a simplified exemplary perspective view of the area 2B in FIG. 2A. As can be seen, the microlens array 108 is located directly above the detector array 104. The detector array 104 includes a plurality of the photon sensitive photodetectors 106(1, 1) to 106(m, n) arranged in m rows and n columns within the detector array 104. Additionally, the microlens array 108 includes a plurality of microlenses 110(1, 1) to 110(s, t) of a spherical geometry arranged in s rows and t columns within the microlens array 108. Each microlens 110 has a plurality of photodetectors 106 associated with it and upon which each microlens 110 will focus light rays 112 emanating at different angles onto a different associated photodetector 106. For example, there may be 10, 20, 100 or more photodetectors 106 positioned directly behind, and associated with, each microlens 110, wherein each associated photodetector 106 receives light rays 112 from the microlens from a different predetermined angle. Each of the photodetectors 106 positioned behind and associated with a specific microlens 110, such that they receive light from that specific microlens 110, are part of the sub-array of photodetectors associated with that specific microlens 110.

Referring to FIG. 2C, a simplified exemplary perspective view of the area 2B in FIG. 2A is depicted. As can be seen, the microlens array 108 is located directly above the detector array 104. The detector array 104 includes a plurality of the photon sensitive photodetectors 106(1, 1) to 106(m, n) arranged in m rows and n columns within the detector array 104. Additionally, the microlens array 108 includes a plurality of spherical microlenses 110(1, 1) to 110(s, t) arranged in s rows and t columns within the microlens array 108, where the s rows and t columns are staggered to form a hexagonal pattern.

Referring to FIG. 2D, a simplified exemplary perspective view of the area 2B in FIG. 2A is depicted. As can be seen, the microlens array 108 is located directly above the detector array 104. The detector array 104 includes a plurality of the photon sensitive photodetectors 106(1, 1) to 106(m, n) arranged in m rows and n columns within the detector array 104. Additionally, the microlens array 108 includes a plurality of microlenses 110(1, 1) to 110(s, t) of non-spherical elliptical geometry, arranged in s rows and t columns within the microlens array 108, where the s rows and t columns are arranged in a staggered geometrical pattern. This arrangement may effectively improve spatial resolution in one dimension at the expense of angular resolution in the orthogonal dimension. For example, as shown in FIG. 2D, the elliptical microlenses exhibit an elongated major axis in Y and a shortened minor axis in X as compared to a spherical microlens of a diameter greater than X and less than Y. In this example the angular resolution in Y is improved, equating to improved ability to resolve pixel disparities in Y and consequently improved depth resolution, while the spatial resolution in Y is degraded equating to a lower Y resolution in the computed 2D imagery. Likewise, the spatial resolution in X is improved, promising higher X resolution in the computed 2D imagery, but at the expense of angular resolution in the X dimension which will have an adverse effect on resolving pixel disparities along the X axis.

Referring to FIG. 2E, a simplified exemplary perspective view of the area 2E in FIG. 2A is depicted. As can be seen, the microlens array 108 is located directly above the detector array 104. The detector array 104 includes a plurality of the photon sensitive photodetectors 106(1, 1) to 106(m, n) arranged in m rows and n columns within the detector array 104. Additionally, the microlens array 108 includes a plurality of microlenses 110(1, 1) to 110(s, t) of non-spherical elliptical geometry, and of dissimilar sizes, arranged in roughly staggered s rows and t columns within the microlens array 108, This arrangement may effectively improve spatial resolution and angular resolution in one dimension at the expense of angular and spatial resolution in the orthogonal dimension.

It will be clear now that the size and geometry of each microlens, and the number of pixels subtended by each microlens, has a direct bearing on the resolution of angular data (pixel disparity) that can be measured, which in turn has a direct bearing on depth, shape and range resolution calculations. Likewise the microlens size and geometry also has a direct bearing on the spatial resolution of the 2D image that may be recovered through computational imaging and the two parameters of angular and spatial resolution are reciprocal and competing. Therefore, it may be advantageous to use a microlens array (MLA) of dissimilar microlens sizes and geometries. For example, in the autonomous vehicle application where a very wide FoV is often desirable, it may be advantageous to select diversity of microlens sizes and shapes and place them within the microlens array so that, for example, the middle of the FoV exhibits superior angular resolution for superior depth measurements, and the periphery of the FoV exhibits superior spatial resolution for superior reconstructed 2D images.

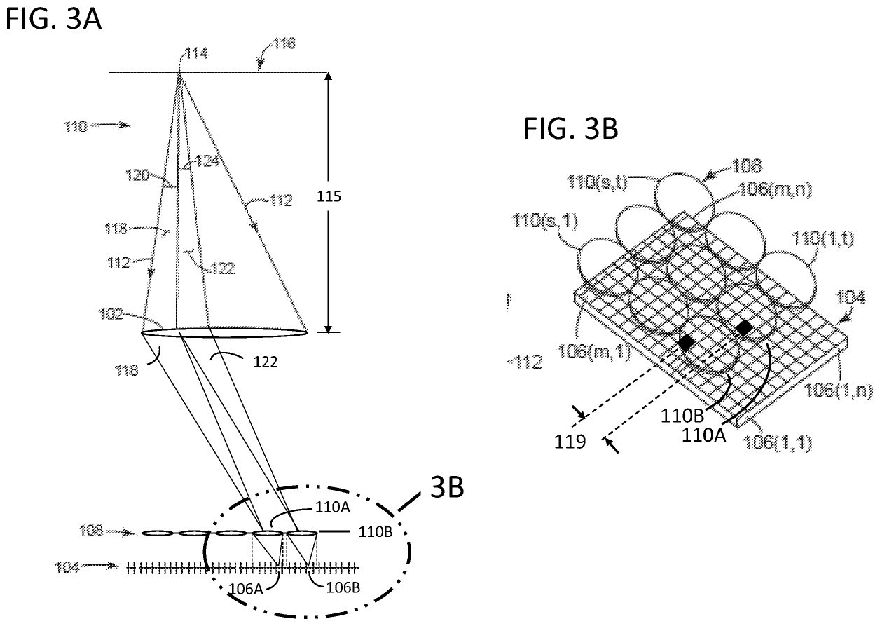

Referring to FIG. 3A, a simplified schematic illustration of the exemplary plenoptic camera 100 of FIG. 2A is depicted, wherein an additional angular subset 122 emanating at a different angle 124 from point 114 is illustrated. The angular subset 122 of photons 112 is also striking microlens 110B. So the photodetector 106B captures substantially all of the light rays (photons) 112 that are traveling within the angular subset 122 from the point 114 to the microlens 110B. However, because of the way the optics are configured, microlens 110A focuses subset 118 onto the photodetector 106A just as microlens 110B focuses the subset 122 onto the photodetector 106B whereby the photodetectors 106A and 106B both image the same point 114. Accordingly, each microlens 110 in the microlens array 108 represents at least a different perspective of the object plane 116, and each photodetector 106 associated with a microlens 110 represents at least a different angle of light 112 that is striking that microlens. Therefore, the image information captured in the microlenses 110 can be processed to determine a two-dimensional parallax data between common object points. The relative position of photodetector 106A within the set of photodetectors under microlens 110A is not the same as the relative position of photodetector 106B within the set of photodetectors under microlens 110B due to the angular disparity between perspectives of the first set of light rays 118 and the second set of light rays 122. The angular disparity is translated to a linear disparity on the photodetector array and the relative difference in position between the first photodetector 106A and second photodetector 106B, commonly known as a pixel disparity, can be used to directly calculate the distance 115 of the point 114 to the camera 110.

Referring to FIG. 3B, a simplified exemplary perspective view of the area 3B in FIG. 3A is depicted. The different angles represented by the plurality of photodetectors 106 associated with at least two microlens 110 can be utilized to generate three dimensional images using computational photography techniques that are implemented by a processor. A plurality of microlenses 110 may represent a perspective of a point 114 (FIG. 3A), or region, on an object plane 116 of an object of interest. For three-dimensional depth information, the same point 114 on the object must be processed by at least two micro-lenses 110. Each microlens 110 will direct the photon from the object onto a photodetector 106 within that microlens' field of view. The relative parallax between the receiving photodetectors is a direct result of the difference in the microlenses' difference in perspective of the object.

By way of example, a pixel under one microlens 110A and a second pixel under microlens 110B both image the same point 114 but have a different relative position under their respective microlens. After the two sub-aperture images are registered, a slight inter-scene displacement can be measured between the two sub-aperture images. Taken down to the smallest measurable degree, namely a pixel (although sub-pixels techniques may also be used), the relative inter-scene shifts can be quantified as pixel disparities. This pixel disparity may occur in both dimensions of the two-dimensional photodiode plane (only one dimension of pixel disparity shown). The difference in relative position of two pixels 119, under dissimilar microlenses 110, is shown and can be used to compute the range 115 from the thermal ranging device to a point 114 on an object using geometry.

Range computation requires knowledge of the main lens and microlenses' focal lengths, and the distance between any two coplanar microlenses producing a registered sub-aperture image. As such, photodetectors associated with dissimilar microlenses can be utilized to determine detailed three-dimensional range and depth information through computational photography techniques that are implemented by a processor.

The techniques described herein can be used to not only quantify the range from the thermal plenoptic camera to a point in the object plane, but they can also be used to determine the shape of an object through the measurement of range to several or many points on an object. By computing the range to many points on a particular object, the object's average range, general shape and depth may also be revealed. Likewise, a topographical map of the area surrounding an autonomous vehicle may also be calculated by treating naturally occurring landscape features as objects of interest.

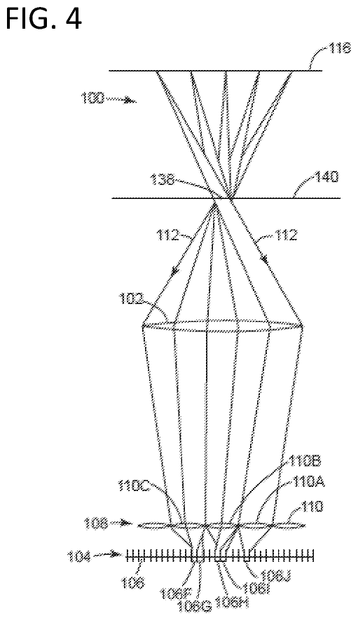

Referring to FIG. 4, a simplified schematic illustration of the exemplary plenoptic camera 100 of FIG. 2A is depicted, wherein different collections of photodetectors 106 are combined from different microlenses 110 to form a new object plane 140. More specifically: a first exemplary collections of photodetectors includes 106F and 106G, and is associated with microlens 110C; a second exemplary collection of photodetectors includes 106H and 106I, and is associated with microlens 110B; and a third collection of photodetectors includes photodetector 106J, and is associated with microlens 110A. The collections of photodetectors, in this example, are chosen so that they all correspond to light 112 emanating from a point, or region, 138 on a new object plane 140. Accordingly, wherein the original image data was focused on the object plane 116, the captured image data can be reassembled to focus on the new object plane 140. Therefore, in contrast to a conventional camera (see camera 10, FIG. 1), the plenoptic camera 100 can adjust the focal plane through, for example, software manipulation of the captured image data in a single shutter actuation period (i.e., in a single frame). Additionally, the image data captured in a single shutter actuation period of the plenoptic camera 100 can be reassembled by a processor to provide perspective shifts and three-dimensional depth information in the displayed image. More specifically, with regard to perspective shifts, at least one photodetector 106 may be selected that is associated with each microlens 110, wherein the selected photodetectors 106 all represent substantially the same light angle. As such, a change in view from different perspectives can be generated.

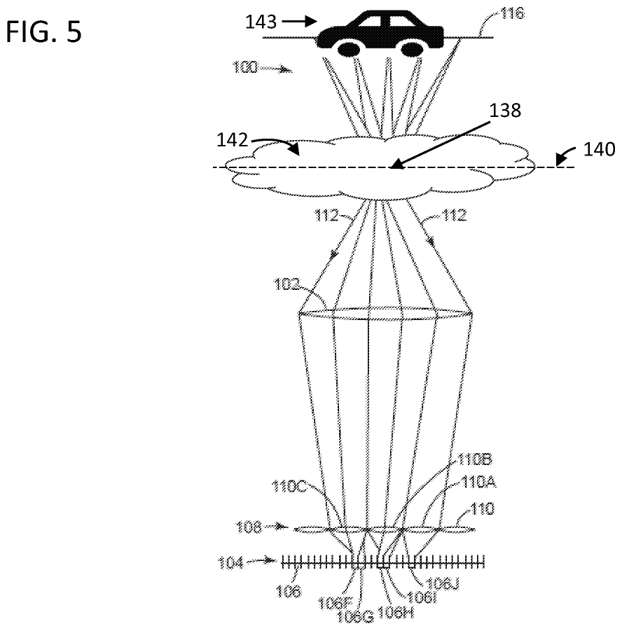

Referring to FIG. 5, a simplified schematic illustrating an example of how forming a new object plane can be used advantageously, by means of example and not limitation, in autonomous vehicle applications.

A conventional camera (see FIG. 1), using a conventional lens suitable for detecting objects at for example 30 meters and 300 meters, will have a long depth of field so that objects at very different ranges are in focus. Therefore, a conventional camera imaging an object, for example a passenger car 143, at an object plane 116, will have difficulty detecting and resolving the object if the camera must image through obscurants 142, for examples particles that attenuate, reflect, refract, scatter or otherwise inhibit satisfactory transmission of the wavelength in use, located at a plane 140 that is also in focus.

With the thermal ranging plenoptic camera described herein, it is possible to create cross sectioned planes of focus through the depth of field. In this manner, if a first plane within the depth of field obscures a view to what lies behind it, then the captured image data through computational imagery may simply create a focused image of a second plane behind the obscurants. The obscurants will still be present, of course, but the thermal ranging camera will view them as not only defocused, and their contributions to the second plane image much diminished, but the camera may also effectively “see around” the obscurants by nature of the many different perspectives available. For example, even obscurants that may be partially in focus in one subaperture image will almost certainly appear differently in other subaperture images due to the different angular perspectives.

Returning to the example illustrated in FIG. 5, the collections of photodetectors, in this example, corresponding to light 112 emanating from a point, or region, 138 on an object plane 140 perceive a cloud of obscurants 142 that mask an object located at a plane behind it 116, in this example an automobile 143. Accordingly, wherein the original image data was focused on the first object plane 140, the captured image data can be reassembled to focus on a second object plane 116. In the composition of the second image plane 116, the obscurants 142 are out of focus, and while the obscurants may slightly attenuate the average brightness of the second image, the obscurants are largely unresolved. Furthermore, due to the many subaperture images and their dissimilar angular perspectives, the obscurants that do resolve or semi-revolve can be mitigated though software manipulation of the captured image data as the location and distribution of obscurants will differ across subaperture images. This feature, unique to the thermal ranging camera, permits thermal imagery to be generated revealing objects of interest behind clouds of obscurants, such as dust and fog, that may otherwise thwart successful imaging by a conventional camera.

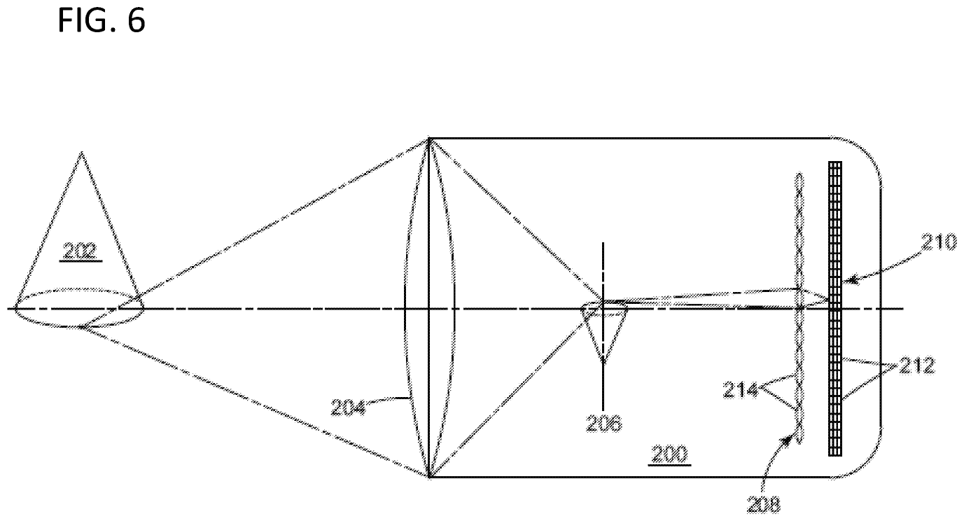

Referring to FIG. 6, a simplified schematic illustration of another exemplary plenoptic camera 200 is depicted. This example of a plenoptic camera is often referred to as a plenoptic 2.0 camera. In this illustration, the plenoptic camera 200 is focused on an external object 202.

The external object 202 radiates thermal energy in the form of infrared radiation that is focused by the main (or collecting) lens 204 to an inverted intermediate focal plane 206. A microlens array 208 is placed between the intermediate image plane 206 and a thermally sensitive detector array 210 at an image plane. The microlens array 208 is comprised of a plurality of microlenses 214 and the detector array 210 is comprised of a plurality of photo sensitive photodetectors 212. In exemplary plenoptic 2.0 camera 200, the microlens array 208 is focused on both the intermediate image plane 206 behind it and photodetectors (or photodetectors) 212 ahead of it. In this configuration the Plenoptic camera 200 forms a thermal image on the detector array 210 that is the aggregate result of each microlens' 214 image. Computational imaging (or computational photography) can then reconstruct a single 2D image from the plurality of 2D images on the detector array 210. Because the position of each microlens 214 is known relative to the photodetectors 212 of the detector array 210, the angle of thermal radiation from each microlens 214 is also known. Accordingly, range and depth information can be determined from the perceived parallax between any two photodetectors 212 viewing the same area of the object 202 through at least two microlenses 214.

A plenoptic camera 200, similar to plenoptic camera 100, captures information (or data) about the light field emanating from an object of interest in the field of view of the plenoptic camera. Such imaging data includes information about the intensity of the light emanating from the object of interest and also information about the direction that the light rays are traveling in space. Through computational imaging techniques (which may be implemented on a separate processor), the imaging data can be processed to provide a variety of images that a conventional camera is not capable of providing. For example, in addition to being able to generate three-dimensional image information of an object of interest, plenoptic camera 200 is also capable of changing focal planes and perspective views on an image captured in a single shutter action (or shutter actuation period) of the camera.

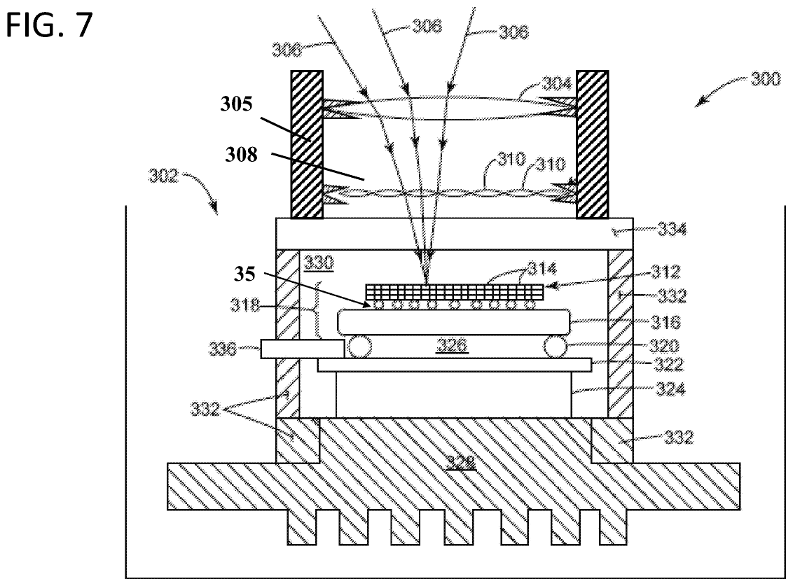

Referring to FIG. 7, a simplified schematic illustration of an embodiment of a thermal ranging plenoptic camera 300 that includes plenoptic optics, as described above with reference to FIGS. 2A-6, is depicted. In the embodiment of FIG. 7, the thermal ranging plenoptic camera 300 includes an integrated detector cooler assembly (IDCA) 302. The thermal ranging camera 300 also includes a main lens 304, fixed in a position by for example a lens mount 305, which collects light photons 306 emanating from an object of interest (not shown). The main lens 304 directs the photons 306 onto a microlens array 308, which includes a plurality of microlenses 310, and which is fixed in position by for example the lens mount 305. The microlenses 310 focus the light photons 306 onto a detector array 312 that is located within the IDCA 302.

In an embodiment, the infrared window may be made of any material that transmits infrared radiation, as way of example silicon, germanium or sapphire. In addition, the infrared window may also act as a cold stop (aperture) and/or be formed to act as a microlens array. In an embodiment, the microlens array is constructed from chalcogenide glass (ChG) with high transmittance for infrared light. In other embodiments the microlens array is constructed from silicon, germanium, magnesium floride, calcium floride, barium floride, sapphire, zinc selenide, AMTIR 1, zinc sulfide, arsenic trisulfide, germanium or silicon. In these embodiments the MLA may feature either an infrared pass filter or infrared rejection filter.

In the embodiment of FIG. 7, components of the IDCA 302 include an infrared window 334, the detector array 312, a read-out integrated circuit (ROIC) 316, a substrate 322, an active cooler 324 and a heat sink 328. The IDCA 302 is contained in a vacuum enclosure 332, such as a Dewar.

The detector array 312 includes a plurality of photosensitive photodetectors 314. Each photodetector 314 generates output signals (i.e., a detector photocurrent) that is based on the number of photons hitting the photodetector 314.

The photodetectors 314 of the detector array 312 may be capable of detecting and producing an output signal for one or more wavebands of light. For example, the detectable wavebands may be in the short wavelength infrared (SWIR) range, having wavelengths in the range of 1 μm-2.5 μm. The detectable wavebands may be in the medium wavelength infrared range (MWIR), having wavelengths in the range of 3 um-5 um. The detectable wavebands may also be in the long wavelength infrared (LWIR) range, having wavelengths in the range of 8 μm-14 μm. In this particular example, the detector array 312 is capable of detecting MWIR and LWIR wavebands.

In the embodiment of FIG. 7, the detector array 312 interfaces to the Read Out Integrated Circuit (ROIC) 316 via indium bumps 35 although other interfaces including, for example, low temperature copper pillars or Micro-Electrical-Mechanical Systems (MEMS) are possible. In an embodiment, the ROIC is configured to output digital image data in response to incident electromagnetic energy. In an embodiment, the ROIC includes analog sense amplifiers, analog-to-digital converters, signal buffers, bias generators and clock circuits, and the ROIC may be referred to generally as a “controller.” The combination of the detector array 312 and the ROIC 316 comprise a focal plane array (FPA) 318. The basic function of the ROIC 316 is to accumulate and store the detector photocurrent (i.e., the photodetector output signals) from each photodetector and to transfer the resultant signal onto output ports for readout. The basic function of the focal plane array 318 is to convert an optical image into digital image data.

In the embodiment of FIG. 7, the ROIC rests upon perimeter CV balls 320 which in turn rest upon substrate 322, although other configurations including wire bonds are possible. In this MWIR LWIR example, the substrate is cooled by the active cooler 324. The active cooler may be, by means of example and not limitation, a Thermo-Electric Cooler (TEC) or a Stirling cooler. Cooling is coupled from the substrate 322 to the ROIC 316 via a thermal underfill or by additional mechanical bump bonds (such as a 2D array of bump bonds, not shown) 326, which, by means of example, may be fabricated from indium or low temperature copper. The active cooler 324 is passively cooled and in conductive contact with heat sink 328. To optimize cooling of the detector array 312 the area 330 around the array 312 is held in vacuum and enclosed by an enclosure 332. The enclosure 332 may be, for example, a Dewar. Although an example of a cooling system is described herein, other types of cooling systems are possible. Infrared radiation 306 (in this case MWIR and LWIR) couples to the detector array 312 through an infrared window 334, which preserves the insulating vacuum and passes infrared energy. Power and signals are passed to and from the IDCA via a vacuum sealed connector 336.

The photodetectors 314 of detector array 312 may be photovoltaic (such as photodiodes or other types of devices that generate an electric charge due to absorption of light photons) or photoconductive (such as micro-bolometers or other types of devices having an electrical resistance that changes due to absorption of light photons). The photoconductive detectors often have a larger time constant and are often slower to react to light photons than photovoltaic detectors. However the photovoltaic detectors often require cooling to lower temperatures than photoconductive detectors, although both technologies will enjoy improved performance with cooling (until detection is shot noise limited).

However, silicon-based photodetectors cannot efficiently detect wavelengths greater than 1 um. Therefore silicon-based photodetectors are generally used to detect wavebands in the visible range (e.g., 400 nm to 750 nm) or NIR range (750 nm to 1 μm). Moreover, non-silicon-based photodetectors are often used as photodetectors for the detection of light in the infrared (IR) ranges, such as the SWIR range (1 μm to 2 μm), the MWIR range (3 μm to 5 μm) or the LWIR range (8 μm to 14 μm). Examples of non-silicon-based detector materials that support fabrication of photovoltaic or photoconductive IR detector arrays include: InGaAs, GaAs, GaSb, InSb, InAs, HgCdTe, and Ge.

However, such non-silicon IR detector arrays must be cryogenically cooled to reduce thermally generated current. More specifically, such non-silicon IR detectors should typically be cooled within a range of, for example, 77 to 200 Kelvin by the active cooler 324.

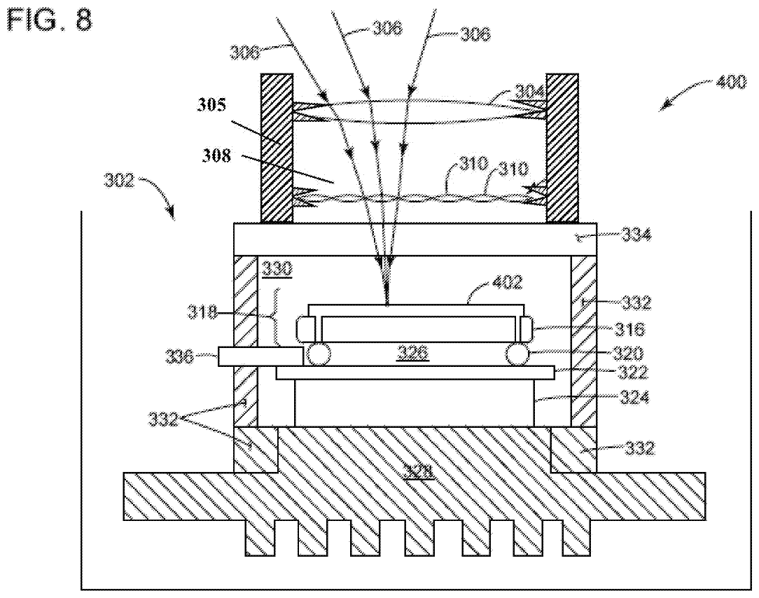

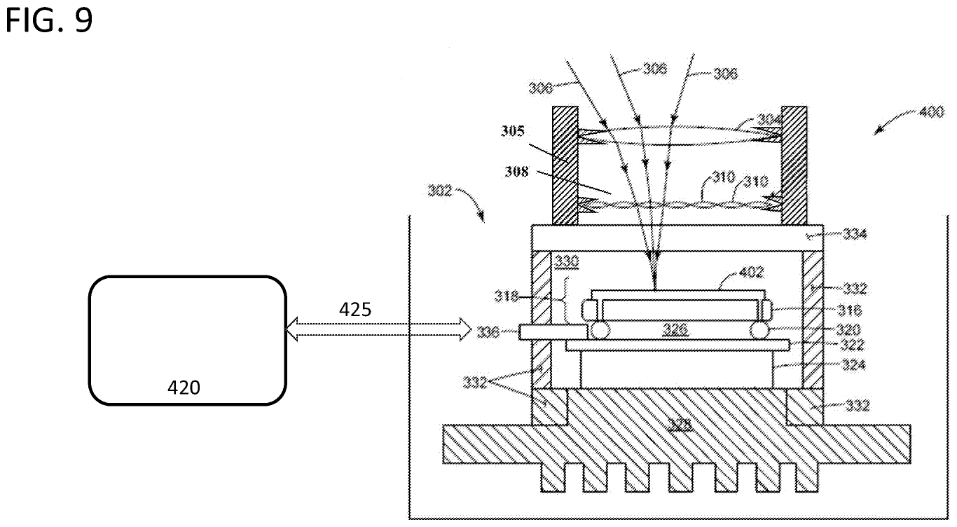

Referring to FIG. 8, a simplified schematic illustration of an embodiment of a thermal ranging plenoptic camera 400 that includes plenoptic optics, as described above with reference to FIGS. 2A-6, is depicted. In the example of FIG. 8, the thermal ranging plenoptic camera 400 includes a detector array 402 composed of Colloidal Quantum Dots (CQDs). CQDs are tiny semiconductor particles a few nanometers in size, having optical and electronic properties. Many types of CQDs, when excited by electricity or light, emit light at frequencies that can be precisely tuned by changing the dots' size, shape and material, therefore enabling a variety of applications. Conversely, CQDs can be made responsive to light, defined by the dots' size, shape and material, so that the CQD material produces electric current in response to illumination.

In an embodiment, CQDs may be applied directly to the ROIC 316 to form the CQD-based detector array 402. The CQD-based detector array 402 detects incident infrared radiation 306 that passes through the infrared window 334. The rest of the IDCA 302 is substantially the same as the embodiment in FIG. 7 and comprises a thermal underlayer 326 to couple the ROIC 316 to an active cooler 324 where the ROIC 316 is supported by perimeter CV balls 320. The IDCA 302 is enclosed by an enclosure 332 that together with the infrared glass 334 provides a vacuum sealed area 330 around the detector array 402.

One advantage that the CQD-based detector array 402 has over other detector arrays that have non-silicon based photosensors, is that a CQD-based detector array does not have to be cooled as much to reduce thermally generated currents. For example, the CQD-based detector array 402 may only need to be cooled to within a range of 200 to 270 Kelvin for acceptable image generation.

Referring to FIG. 8, a simplified schematic illustration of a system embodiment of a thermal ranging plenoptic camera 400, a Graphics Processing Unit (GPU) 420 and a camera digital link 425. The GPU 420, supports the computational photography tasks such as rendering one or more 2Ds image at one or more depths of field and range, depth and shape information of objects within the image. Data is transmitted from the thermal ranging plenoptic camera to the GPU via a communications line 425 that may a digital output based for example a MIPI CSI-2 or GigE and Camera-Link. Two-dimensional images may be rendered in any manner of resolution, for example including subsampling to decrease resolution and digital zooming to fill larger image files. The thermal ranging camera may output digital images of varying aspect ratios as well including those greater than 21:9.

A method for 4D thermal light-field detection which includes Plenoptic optics comprising a main lens and printed film or micro-lens array, a single focal plane comprising a plurality of non-silicon detectors responsive to IR and a silicon Read Out Integrated Circuit (ROIC), which can be coupled to a digital acquisition and computational photography device. The ROIC generates frames of image data over a region of interest and consecutive frames of image data constitute a video stream. Computational photography is used to extract 3D (2D intensity plus depth) images as well as selective depth-of-field and image focus from the acquired 4D light-field data.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device comprising:
a lens, operative in the infrared, configured to receive an image of a field of view of the lens;
a microlens array, operative in the infrared, optically coupled to the lens and configured to create an array of light field images based on the image;
a photodetector array comprising a plurality of non-silicon photodetectors, photosensitive in at least part of the thermal spectrum from 3 microns to 14 microns, the photodetector array being optically coupled to the microlens array and configured to generate output signals from the non-silicon photodetectors based on the array of light field images; and
a read-out integrated circuit (ROIC) communicatively coupled to the photodetector array and configured to receive the signals from the photodetector array, convert them to digital signals and to output digital data.

2. The device of claim 1, where a vacuum package encloses the detector and the ROIC.

3. The device of claim 1, where an optical window predominantly transmissive to IR radiation optically couples the lens to the microlens array.

4. The device of claim 1, wherein the photodetector array comprises a plurality of photodetectors sensitive to the MWIR band.

5. The device of claim 1, wherein the photodetector array comprises a plurality of photodetectors sensitive to the LWIR band.

6. The device of claim 1, where the photodetector array is a Strained Lattice (including T2SL and nBn) 2D array hybridized to the ROIC and fabricated with at least one of GaSb and InSb and GaAs and InAs and HgCdTe.

7. The device of claim 1, where the photodetector array is deposited onto the ROIC and fabricated from at least one of VOx microbolometer and a poly-silicon microbolometer and a polycrystalline microbolometer and Colloidal Quantum Dots.

8. The device of claim 1, wherein the photodetector array comprises a plurality of quantum dots photodetectors.

9. The device of claim 1, wherein the non-silicon photodetectors comprise Colloidal Quantum Dots that are used in a photovoltaic mode of operation.

10. The device of claim 1, wherein the photodetector array comprises a plurality of photovoltaic photodetectors.

11. The device of claim 1, wherein the photodetector array comprises a plurality of photoconductive photodetectors.

12. The device of claim 1, wherein each lenslet within the microlens array has at least one of an infrared pass coating and an infrared block coating.

13. The device of claim 1, wherein the photodetector array is thermally coupled to an active cooler that cools the photodetector array to a temperature in the range of 77 Kelvin to 220 Kelvin.

14. The device of claim 13, wherein the active cooler is a Stirling cooler.

15. The device of claim 13, wherein the active cooler is a Thermal Electric Cooler (TEC) in thermal contact with the ROIC and at least partially enclosed in the package vacuum.

16. The device of claim 15, wherein a cold plate of the TEC is also a printed circuit board (PCB) providing electrical interface to the ROIC.

17. The device of claim 1, wherein the ROIC includes a plurality of Through Silicon Via (TSV) interconnects used to transmit controls and data to/from the ROIC.

18. The device of claim 1, further comprising a digital output based on at least one of MIPI CSI-2 and GigE and Camera-Link.

19. The device of claim 1, wherein the lens and microlens array are configured as a contiguous depth-of-field plenoptic V2.0 system.

20. The device claim 1, wherein a computational photograph is performed by software on a Graphics Processing Unit (GPU).

21. The device of claim 1, where the microlens array comprises spherical lenslets.

22. The device of claim 1, where the microlens array comprises aspherical lenslets.

23. The device of claim 1, wherein lenslets that comprise the microlens array have asymmetrical X & Y dimensions.

24. The device of claim 1, wherein the microlens array comprises lenslets arranged in a hexagonal pattern.

25. The device of claim 1, wherein the microlens array comprises lenslets arranged in an orthogonal pattern.

26. The device of claim 1, wherein the microlens array comprises lenslets of at least one of dissimilar sizes and dissimilar shapes.

27. The device of claim 1, wherein a plenoptic digital image output has greater than or equal to 21:9 aspect ratio.

28. The device of claim 1, wherein a processor computes at least two depths of field based on thermal plenoptic data.

29. A ranging system comprising the device of claim 1 and a processor configured to generate data to reconstitute at least one of a two-dimensional and three-dimensional image of the field of view based on the digital data received from the ROIC.

30. The ranging system of claim 29, wherein the processor is configured to compute at least two depths of field based on the digital data received from the ROIC.

31. The device of claim 1, wherein the ROIC comprises:
a plurality of analog sense amplifiers responsive to said infrared detectors;
a plurality of Analog to Digital Converters (ADC) responsive to a plurality of said sense amplifiers;
a light-field image digital output; and
a digital acquisition controller.

32. A method of determining a thermal image, the method comprising:
receiving, through a lens operative in the infrared, an image of a field of view of the lens;
creating an array of light field images based on the image, from a microlens array, operative in the infrared, and optically coupled to the lens;
sensing, by a plurality of non-silicon infrared detectors, the array of light field images;
digitizing, by a silicon based Read Out Integrated Circuit (ROIC), an output from the non-silicon detectors; and
generating output signals, based on the array of light field images.

33. The method of claim 32, further comprising generating an image including at least one of range and shape and depth information of an object in the field of view based on the light field data.

34. The method of claim 32, wherein the ROIC comprises:
a plurality of analog sense amplifiers responsive to said infrared detectors;
a plurality of Analog to Digital Converters (ADC) responsive to a plurality of said sense amplifiers;
a light-field image digital output; and
a digital acquisition controller.
